(19) United States
(12) Patent Application Publication
(10) Pub. No.: US 2004/0209163 A1
(43) Pub. Date: Oct. 21, 2004

(54) Electrochemical cell

(76) Inventors: Shunji Watanabe, Miyagi (JP); Takashi Kaito, Chiba-shi (JP); Toshiaki Fujii, Chiba-shi (JP); Kouji Iwasaki, Chiba-shi (JP); Shigeru Wakiyama, Chiba-shi (JP)

Correspondence Address: ADAMS & WILKS, 31st Floor, 50 Broadway, New York, NY, 10004, US

(21) Appl. No.: 10/793,288

(22) Filed: Mar. 4, 2004

(30) Foreign Application Priority Data
Apr. 17, 2003 (JP) 2003-112620

(51) Int. Cl. H01M 2/30

(52) U.S. Cl. 429/178

(57) ABSTRACT

A tin coating is, for example, considered as a lead-free solder coating for a terminal attached to an electrochemical cell, but has presented a problem, as whiskers are likely to occur from the tin coating when the terminal is attached to the cell by laser welding. The formation of whiskers is due to the heat of laser welding and can be restrained by optimizing an undercoat layer of nickel or a nickel alloy.

### BACKGROUND OF THE INVENTION

1. Field of the Invention

This invention relates to an electrochemical cell, such as a button- or coin-shaped battery, or capacitor.

2. Description of the Related Art

It has hitherto been usual to use an electrochemical cell, such as a coin- or button-shaped primary or secondary cell, or capacitor as an auxiliary power source for a portable machine or instrument, or as a backup power source for a clock or memory, by attaching thereto terminals for taking leads for positive and negative electrodes. It has recently become possible to make terminals in a smaller size. There is known a terminal of the type which is inserted in a terminal hole in a mounting substrate and soldered to its rear side (for example, see Patent Document 1). The main trend is, however, of the surface mounting type in which a secondary cell or capacitor having terminals attached thereto is placed on a substrate and a solder coating given to the end of each terminal is soldered to the surface of the substrate (for example, see Patent Document 2). A tin-lead (Sn—Pb) alloy is mainly used for the solder coating at the end of each terminal.

Patent Document 1—JP-UM-A-61-18568

Patent Document 2—JP-A-11-40174

An increased attention to environmental problems has recently been calling for a reduction in the use of any environmental contaminant in machines and instruments. As a result, it has become necessary to eliminate lead (Pb) from the solder coating given to the ends of terminals attached to an electrochemical cell. A tin coating is, for example, considered as a substitute, but has presented a problem, as whiskers are likely to occur from the tin coating when terminals are attached to an electrochemical cell by laser welding. The whiskers cause a short circuit and thereby destroy a machine or instrument having an electrochemical cell mounted therein.

### SUMMARY OF THE INVENTION

According to this invention, the problem pointed out above is overcome by a coin- or button-shaped electrochemical cell having a terminal connected to at least one of negative and positive electrodes for taking a lead thereto, the terminal having a nickel (Ni) or nickel alloy undercoat layer formed on its surface and a tin (Sn) or tin alloy surface layer formed thereon. The terminal may be connected to at least one of the negative and positive electrodes by laser welding.

The undercoat layer may have a thickness of 0.3 to 5 microns and the surface layer may have a thickness of 1 to 7 microns. The undercoat layer may be of nickel, an alloy of nickel and boron (B) or an alloy of nickel and phosphorus (P) and the surface layer may be an alloy of tin and bismuth (Bi), an alloy of tin and silver (Ag) or an alloy of tin and copper (Cu).

The terminal may have a thickness of 0.07 to 0.25 mm. The terminal may be joined to the can by a weld spot formed by laser radiation on the surface of the terminal and having a diameter of 0.3 to 0.6 mm and a depth of 0.1 to 0.3 mm. The surface layer and the laser weld spot closest thereto have therebetween a distance which is at least 10 times the thickness of the terminal, when the nickel or nickel alloy layer as the undercoat layer has a thickness of 0.3 micron.

### BRIEF DESCRIPTION OF THE DRAWING

FIG. 1 is a schematic side view of an electrochemical cell embodying this invention.

### DETAILED DESCRIPTION OF THE INVENTION

It has been considered that whiskers occurring to the terminal attached to an electrochemical cell are produced by the heat of laser welding, and studies have, therefore, been made of the conditions of laser welding not allowing the formation of whiskers. It has also been found that such whiskers are very unlikely to occur to a terminal having a surface layer of tin or a tin alloy and an undercoat layer of Ni or a Ni alloy formed thereon, and studies have, therefore, been made of the desirable compositions and thicknesses of the surface and undercoat layers.

It is known that tin whiskers are solid whiskers of the type growing from a metal having a low recrystallization temperature. As tin has a recrystallization temperature of 0 to 25° C., its whiskers are formed as a result of a temperature change occurring to the terminal during laser welding. Examination has, therefore, been made to see what effects the heat and the conditions of laser radiation would have on the formation of whiskers. Each terminal employed was a sheet of stainless steel (SUS 304) having a width of 4 mm and a length of 10 mm and coated with a specific undercoat layer and a tin or tin alloy surface layer. It was secured by laser welding to a button-shaped cell having a diameter of 6.8 mm. The formation of whiskers was evaluated by employing stainless steel terminals having different thicknesses, undercoat layers of different compositions and thicknesses, surface layers of different compositions and thicknesses and different laser welding conditions (different weld diameters and depths), as will be described in Examples. The evaluation of whiskers was made by employing a scanning electron microscope to see the presence of whiskers having a length of about 30 microns one and 30 days after welding. The examination made one day after welding was made to see the distance between the weld spot and the whiskers found around it. The cells were held at a temperature of 23° C. plus or minus 3° C.

### EXAMPLES 1 TO 4

In each of Examples 1 to 4, a terminal was made by coating a stainless steel sheet having a thickness of 0.1 mm with an undercoat layer of nickel and a surface layer of tin having a thickness of 3 microns. The thickness of the undercoat layer comprising nickel coating was made different from one Example to another. Then, Examples 1 to 4 were made by laser welding with a weld diameter of 0.4 mm and a weld depth of 0.125 mm. Comparative Example 1 was made different from Examples 1 to 4 by employing an undercoat layer of copper, and Comparative Example 2 by employing a very small nickel layer thickness (0.2 microns). Other details and the results of examination as to whiskers are shown in Table 1.

TABLE 1

| | Stainless | | | | | | | Area covered by | |
|---|---|---|---|---|---|---|---|---|---|
| | steel | Undercoat | | Surface | | Laser welding | | whiskers (one day | |
| | sheet | layer | | layer | | Weld | Weld | after welding) | Growth of |
| | Thickness | | Thickness | | Thickness | diameter | depth | Radius | whiskers (30 days |
| | (mm) | Type | (μm) | Type | (μm) | (mm) | (mm) | (mm) | after welding) |
| Comp. | 0.1 | Cu | 1 | Sn | 3 | 0.4 | 0.125 | The whole | Found |
| Ex. 1 | | | | | | | | terminal surface | |
| Comp. | 0.1 | Ni | 0.2 | Sn | 3 | 0.4 | 0.125 | Within a radius of | Found |
| Ex. 2 | | | | | | | | 3 mm from the | |
| | | | | | | | | laser weld spot | |
| Ex. 1 | 0.1 | Ni | 0.3 | Sn | 3 | 0.4 | 0.125 | Within a radius of | Not found |
| | | | | | | | | 1 mm from the | |
| | | | | | | | | laser weld spot | |
| Ex. 2 | 0.1 | Ni | 0.5 | Sn | 3 | 0.4 | 0.125 | — | — |
| Ex. 3 | 0.1 | Ni | 1 | Sn | 3 | 0.4 | 0.125 | — | — |
| Ex. 4 | 0.1 | Ni | 5 | Sn | 3 | 0.4 | 0.125 | — | — |

In Comparative Example 1 employing an undercoat layer of copper, whiskers were found both one and 30 days after welding. The growth of whiskers was found 30 days after welding. In Comparative Example 2 employing a nickel undercoat layer having a thickness as small as 0.2 micron, whiskers were found in an area having a radius of 3 mm from the laser weld spot one day after welding. It is apparent that the heat of laser welding promoted the formation of whiskers. It is generally understood that the formation of whiskers is likely to occur at a temperature in the vicinity of 50° C. Therefore, a thermocouple having a diameter of 0.1 mm was brazed to the terminal at each of points 1 and 3 mm apart from the laser weld spot for measuring its temperature during welding, and showed a temperature of 60° C. or 38° C. at the point 1 or 3 mm apart, respectively.

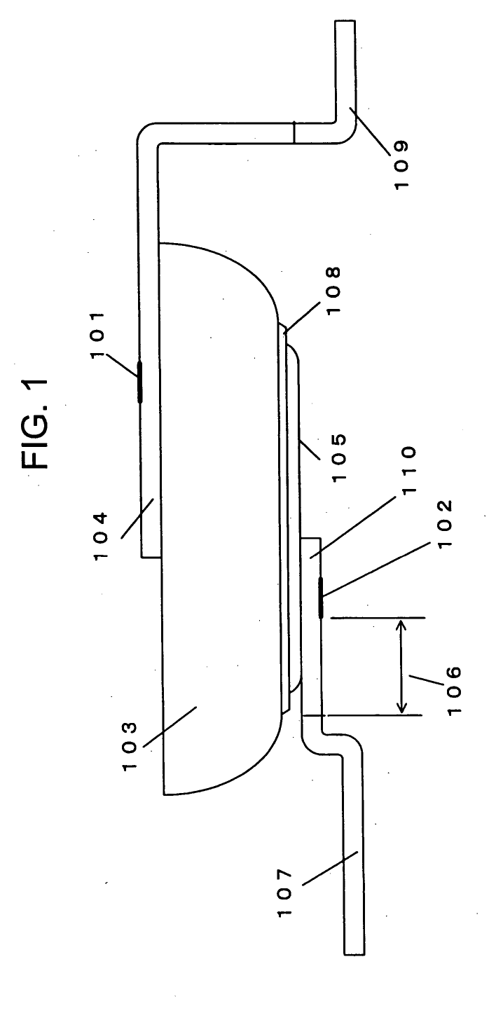

Reference is made to FIG. 1 showing an electrochemical cell embodying this invention in side view. The cell has a positive electrode can 103 and a negative electrode can 105 spaced apart from each other by a gasket 108. Positive and negative electrode terminals 104 and 110 are joined to the positive and negative electrode cans 103 and 105, respectively. The cans and terminals are joined to each other by the application of laser light to laser weld spots 101 and 102, respectively. The positive and negative electrode terminals 104 and 110 have coating layers 107 and 109 formed thereon, respectively. Each coating layer is formed by an undercoat layer of nickel or a nickel alloy and a surface layer of tin or a tin alloy.

In Example 1, the undercoat layer of nickel has a thickness of 0.3 micron. In Example 1, whiskers were slightly found in an area having a radius of 1 mm from each laser weld spot, but did not present any problem in practical use, as they did not grow during further storage. When the nickel layer has a thickness of 0.3 mm, therefore, it is possible to form a tin layer where the whisker does not produce a dangerous portion as a result of laser welding if the coating has a distance 106 of at least 1 mm from the laser weld spot. Under those welding conditions, no whisker was formed when the distance between the tin layer and the weld spot was about 10 times the terminal thickness. In Examples 2 to 4 each employing a greater nickel layer thickness, no whisker was found either one or 30 days after welding. The greater the nickel layer thickness, the more effectively it is possible to avoid the formation of whiskers. In the event that the terminal is bent or otherwise worked after the nickel layer is formed, its thickness not exceeding 5 microns is suitable, since a nickel layer having a greater thickness is likely to peel off. Similar tests were conducted on a nickel alloy coating containing 2 to 9% of phosphorus and a nickel alloy coating containing 1 to 5% of boron and substantially the same results were obtained as in the case of a nickel coating.

### EXAMPLES 5 TO 8

The tin layer thickness was likewise studied. Examples 5 to 8 were prepared with different tin layer thicknesses. An undercoat layer of copper and a surface layer of tin having a thickness of 10 microns were employed in Comparative Example 3. In Comparative Example 4, the surface layer of tin had a thickness of 0.5 micron. Other details and the results of examination for whiskers are shown in Table 2.

TABLE 2

| | Stainless | | | | | | | Area covered by | |
|---|---|---|---|---|---|---|---|---|---|
| | steel | Undercoat | | Surface | | Laser welding | | whiskers (one day | |
| | sheet | layer | | layer | | Weld | Weld | after welding) | Growth of |
| | Thickness | | Thickness | | Thickness | diameter | depth | Radius | whiskers (30 days |
| | (mm) | Type | (μm) | Type | (μm) | (mm) | (mm) | (mm) | after welding) |
| Comp. | 0.1 | Cu | 1 | Sn | 10 | 0.4 | 0.125 | Within a radius of | Not found |
| Ex. 3 | | | | | | | | 1 mm from the | |
| | | | | | | | | laser weld spot | |
| Comp. | 0.1 | Ni | 1 | Sn | 0.5 | 0.4 | 0.125 | Within a radius of | Not found |
| Ex. 4 | | | | | | | | 1 mm from the | |
| | | | | | | | | laser weld spot | |
| Ex. 5 | 0.1 | Ni | 1 | Sn | 1 | 0.4 | 0.125 | — | — |
| Ex. 6 | 0.1 | Ni | 1 | Sn | 2 | 0.4 | 0.125 | — | — |
| Ex. 7 | 0.1 | Ni | 1 | Sn | 5 | 0.4 | 0.125 | — | — |
| Ex. 8 | 0.1 | Ni | 1 | Sn | 7 | 0.4 | 0.125 | — | — |

In Comparative Example 3, whiskers were found only in the vicinity of the weld spot and no more whiskers were formed even after 30 days of storage. Although a tin layer having a large thickness on an undercoat layer of copper does not form whiskers easily, it is not practical, since it is likely to peel off easily. Although whiskers were found only in the vicinity of the weld spot in Comparative Example 4, too, and no more whiskers were formed even after 30 days of storage, it was found when such a terminal was soldered to an electrochemical cell that the tin layer was too small in thickness to achieve any satisfactory peel strength on the substrate and withstand practical use.

In Examples 5 to 8 each employing a greater tin layer thickness, no whisker was found either one or 30 days after welding. Similar tests were conducted on a tin alloy coating containing 2 to 9% of bismuth, a tin alloy coating containing 1 to 5% of silver and a tin alloy coating containing 1 to 5% of copper and substantially the same results were obtained as in the case of a tin coating. A thickness not exceeding 7 microns is, however, suitable for a tin alloy coating, since a tin layer having a greater thickness is likely to crack when bent.

### EXAMPLES 9 TO 12

Studies were made about the thickness of stainless steel sheets for terminals and the laser welding conditions. A greater stainless steel sheet thickness requires a higher laser radiation intensity for welding. As a result, a greater amount of heat is produced during welding. Examples 9 to 12 were prepared with different stainless steel sheet thicknesses. In Comparative Example 5, the stainless steel sheet had a thickness of 0.06 micron, and in Comparative Example 6, a thickness of 0.3 mm. Other details and the results of examination for whiskers are shown in Table 3.

TABLE 3

| | Stainless | | | | | | | Area covered by | |
|---|---|---|---|---|---|---|---|---|---|
| | steel | Undercoat | | Surface | | Laser welding | | whiskers (one day | |
| | sheet | layer | | layer | | Weld | Weld | after welding) | Growth of |
| | Thickness | | Thickness | | Thickness | diameter | depth | Radius | whiskers (30 days |
| | (mm) | Type | (μm) | Type | (μm) | (mm) | (mm) | (mm) | after welding) |
| Comp. | 0.06 | Ni | 1 | Sn | 3 | 0.2 | 0.08 | Within a radius of | Not found |
| Ex. 5 | | | | | | | | 1 mm from the | |
| | | | | | | | | laser weld spot | |
| Comp. | 0.3 | Ni | 1 | Sn | 3 | 0.7 | 0.33 | Within a radius of | Not found |
| Ex. 6 | | | | | | | | 3 mm from the | |
| | | | | | | | | laser weld spot | |
| Ex. 9 | 0.07 | Ni | 1 | Sn | 3 | 0.3 | 0.1 | — | — |
| Ex. 10 | 0.15 | Ni | 1 | Sn | 3 | 0.4 | 0.18 | — | — |
| Ex. 11 | 0.2 | Ni | 1 | Sn | 3 | 0.5 | 0.22 | — | — |
| Ex. 12 | 0.25 | Ni | 1 | Sn | 3 | 0.6 | 0.28 | — | — |

In Comparative Example 5, whiskers were formed apparently due to a large temperature elevation which had occurred in the vicinity of the laser weld spot, since the stainless steel sheet thickness was too small. Although no whiskers were found in Comparative Example 5 after 30 days of storage, it was found when the terminal was soldered to a n electrochemical cell that the stainless steel sheet was too small in thickness for any practical use, since a substrate drop test resulted in a broken terminal.

In Comparative Example 6, the stainless steel sheet was so large in thickness as to require a higher laser radiation intensity and thereby a weld depth which was greater than its thickness. More specifically, it required a weld diameter of 0.7 mm and a weld depth of 0.33 mm. Whiskers were formed in a large area having a distance of 3 mm from the weld spot apparently because of a great temperature elevation which had been brought about in the vicinity of the weld spot by intense laser radiation. No more whiskers were formed by 30 days of storage.

Examples 9 to 12 employed a stainless steel sheet thickness differing from 0.07 mm to 0.25 mm and the optimum laser welding conditions for each terminal thickness. Good results were obtained without any whiskers formed either one or 30 days after welding. The same tests were conducted on other kinds of stainless steel (such as SUS430, 444 and 316) and showed substantially the same results.

Although the layers formed by coating were employed in the Examples described above, the same results can be expected from any layer formed by a different method if it is of the same composition. Evaporation, sputtering or CVD can, for example, be employed without presenting any problem.

This invention is concerned with an electrochemical cell having terminals attached thereto and is applicable to any type of electrochemical cell, such as a primary or secondary cell, or an electrical double layer capacitor. It is suitable for any purpose not specifically limited, only if there is an electronic circuit substrate to which the cell can be mounted. The cell may be joined to the substrate by any method not specifically limited, such as with a soldering iron or by reflow soldering.

A coin- or button-shaped electrochemical cell having terminals attached thereto has a tin or tin alloy layer not containing lead on the surface of each terminal and thereby overcomes any fear of whiskers being formed thereon, as is obvious from the foregoing description. This makes it possible to restrain any environmental pollution in the event that any machine or instrument including the electrochemical cell according to this invention is disposed of. Moreover, the absence of whiskers makes it possible to avoid any short circuiting in the substrate on which the electrochemical cell according to this invention is mounted, and thereby reduce the possibility of any machine or instrument failure.

What is claimed is:

1. An electrochemical cell having a terminal attached thereto for taking an electrical lead, the terminal having a surface layer of tin or a tin alloy formed thereon and an undercoat layer of nickel or a nickel alloy formed under the surface layer.

2. The electrochemical cell according to claim 1, wherein the terminal is joined to at least one of negative and positive electrodes by laser welding.

3. The electrochemical cell according to claim 2, wherein the undercoat layer has a thickness of 0.3 to 5 microns.

4. The electrochemical cell according to claim 2, wherein the surface layer has a thickness of 1 to 7 microns.

5. The electrochemical cell according to claim 2, wherein the undercoat layer comprises any of a nickel layer, a layer of nickel and boron and a layer of nickel and phosphorus.

6. The electrochemical cell according to claim 2, wherein the surface layer comprises any of a layer of tin and bismuth, a layer of tin and silver and a layer of tin and copper.

7. The electrochemical cell according to claim 2, wherein the terminal has a thickness of 0.07 to 0.25 mm and a weld formed by the laser welding has a diameter of 0.3 to 0.6 mm exposed on the surface of the terminal and a depth of 0.1 to 0.3 mm.

8. The electrochemical cell according to claim 2, wherein the undercoat layer has a thickness of 0.3 micron, and the surface layer and the laser weld spot closest thereto have therebetween a distance which is at least 10 times the thickness of the terminal.

9. The electrochemical cell according to claim 1, wherein the undercoat layer has a thickness of 0.3 to 5 microns.

10. The electrochemical cell according to claim 1, wherein the surface layer has a thickness of 1 to 7 microns.

11. The electrochemical cell according to claim 1, wherein the undercoat layer comprises any of a nickel layer, a layer of nickel and boron and a layer of nickel and phosphorus.

12. The electrochemical cell according to claim 1, wherein the surface layer comprises any of a layer of tin and bismuth, a layer of tin and silver and a layer of tin and copper.
